(19) United States
(12) Patent Application Publication
(10) Pub. No.: US 2014/0188978 A1
(43) Pub. Date: Jul. 3, 2014

(54) CLOUD-BASED MEDIA PROCESSING PIPELINE

(71) Applicant: MICROSOFT CORPORATION, Redmond, WA (US)

(72) Inventors: Samuel NG, Bellevue, WA (US); Sudheer Sirivara, Redmond, WA (US); Jonathan Hawkins, Seattle, WA (US); John Deutscher, Sammamish, WA (US)

(73) Assignee: Microsoft Corporation, Redmond, WA (US)

(21) Appl. No.: 13/731,116

(22) Filed: Dec. 31, 2012

(51) Int. Cl. H04L 29/08

(52) U.S. Cl. CPC H04L 67/10
USPC 709/203

(57) ABSTRACT

A cloud-based media processing service facilitates digital media production through workflows that are designed to facilitate various types of media transformations. A workflow enables a media publisher to more easily construct jobs that are processed by the cloud-based media processing service. The cloud-based media processing service receives requests to perform jobs, which are customized instances of a workflow, and which are processed within the cloud-based media processing service.

### BACKGROUND

Digital media production is a process in which digital media files are created, encoded and distributed. The digital media files represent any type of media content such as audio, video, image and text. The production of video content is especially challenging due to the variety of variables that may be used to produce and playback digital video. There are various video format options, packaging options, playback device constraints, and codec parameters. There are various video formats, such as MPEG2, MPEG4, and H.264, and various container formats, such as AVI, ASF, MP4, MOV, VOB, FLV, etc. In addition some playback devices may only support certain video file formats and/or container formats.

Codecs, which are used to compress a digital file, have various settings, such as the data rate, frame rate, and frame size, which affect the size of the video file and image quality. The video playback size and data rate may differ from different playback devices. Newer versions of a playback device may support higher resolution video and playback quality while legacy playback devices may support a lower resolution video. In addition, digital video streamed from the Internet demand a smaller-sized video file.

The production of a video typically includes generating multiple versions of the video in each of the various configurations that are possible. For a large number of videos, the task may be challenging to manage and produce.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A cloud-based media processing service facilitates digital media production by providing a media publisher with workflows designed to perform commonly-used tasks used in digital media production. A workflow is a template of a transformation that is composed of an ordered sequence of tasks. A media publisher uses the workflow to generate jobs that perform customized tasks tailored for the media publisher's use.

The functions of the cloud-based media processing service are distributed among several components in order to provide a highly-scalable and highly-available service. The cloud-based media processing service contains an interface that interacts with a media publisher receiving requests for service and replying to the media publisher with responses. A job request is placed in the media publisher's job queue and prioritized with respect to other jobs received by the service. The resources needed for a job are then allocated and the job is processed. The results of the job are placed in a web-accessible location for the media publisher to peruse.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a block diagram illustrating an exemplary system implementing a cloud-based media processing service.

FIG. 2 illustrates an exemplary encoder workflow.

FIG. 3 illustrates additional exemplary workflows.

FIG. 4 is a block diagram illustrating components of the cloud-based media processing service that service requests to store assets from a media publisher in the cloud-based media processing service.

FIG. 5 is a flow diagram illustrating an exemplary method for servicing requests to store assets in the cloud-based media processing service.

FIG. 6 is a block diagram illustrating components of the cloud-based media processing service that execute jobs.

FIG. 7 is a flow diagram illustrating an exemplary method for processing job requests in the cloud-based media processing service.

FIG. 8 is a block diagram illustrating an exemplary operating environment.

FIG. 9 is a block diagram illustrating an exemplary computing device.

### DETAILED DESCRIPTION

Various embodiments pertain to a cloud-based media processing service that facilitates digital media production. The service provides a media publisher with workflows to perform various types of transformations on media assets. The functions of the cloud-based media processing service are distributed among several components in order to provide a highly-scalable and highly-available service. In this manner, a media publisher (i.e., media vendor, user, media provider, media distributor, developer, etc.) does not need to bear the cost of maintaining a datacenter to facilitate its own digital media production.

Attention now turns to a discussion of a system 100 for a cloud-based media processing service. The system 100 may include one or more media publishers 102A-102N (collectively, “102”) coupled through a communication framework 104, such as the Internet, to a cloud-based media processing service 106.

A media publisher 102, using a computing device, may interact with the cloud-based storage service 106 through a series of Representational State Transfer Application Programming Interfaces, REST APIs. The REST APIs rely on the HTTP protocol to execute methods remotely at the cloud-based media processing service. The REST APIs define a series of function calls that the media publisher uses to request services from the cloud-based storage service through the HTTP protocol. The Hypertext Transfer Protocol (HTTP) is a data transfer protocol used on the World Wide Web. The HTTP protocol is a request/response protocol used to exchange data typically between a web browser and a web-accessible server.

The cloud-based media processing service 106 may include an interface 108, one or more job queues 110, a scheduler 112, a prioritized task queue 114, an account storage 116, a metadata storage 118, a resource scheduler 120, a key manager 122, and multiple servers, 124A-124N (collectively, “124”).

The interface 108 interacts directly with the various media publishers 102. The interface 108 may be implemented as a computing device that receives a request from a media publisher, processes the request, and returns a response. More particularly, the interface 108 receives a function call or request through the REST APIs and executes the method associated with the function call at the interface 108. The interface 108 transmits a response back to the media publisher in response to execution of the method associated with the REST API.

The account storage 116 stores the media assets 128 and specialized executable programs, such as encoders 130 and transcoders 132. Each media publisher 102 may have a dedicated portion of space in the account storage 116 to store its media assets 128. The account storage 116 may be implemented as any type of storage device, such as without limitation, a file system, a storage system, a server, a network storage device, and the like, and/or any combination thereof. The media assets 128 may be any type of digital media file that contains any type of media content, such as without limitation, video, audio, text, images, and so forth.

The metadata storage 118 may be used to store the workflows 134 and metadata 136 associated with each media asset. The metadata storage 118 may be implemented as an SQL server, a database server, a file system, and the like and/or any combination thereof.

A key manager 122 may be used to generate one or more keys to access a media asset. Some media assets may be encrypted and as such, need an encryption key to decrypt the media asset prior to using the media asset and to encrypt the media asset after transforming the media asset. The encryption key associated with the media asset may be stored in the metadata associated with the media asset.

Each media publisher 102 utilizing the services of the cloud-based media processing service has a dedicated job queue 110 that stores pending jobs. A scheduler 112 polls each job queue 110 and determines an execution order for each task waiting for execution. The tasks are then placed in a prioritized task queue 114 in the execution order determined by the scheduler 112. A resource scheduler 120 pulls each task off the prioritized task queue 114 and allocates the needed resources for the task to execute using one or more of the servers 124. The servers 124A-124N are configured with the resources needed to execute a task. Depending on the nature of the task, a task may be executed across multiple servers 124.

The various elements of the cloud-based media processing service may be communicatively coupled through a communication framework 126. The communication framework may be any type of communication medium, which is well-known in the art.

In various embodiments, the system 100 described herein may comprise a computer-implemented system having multiple elements, programs, procedures, modules, such as without limitation, a mobile device, a personal digital assistant, a mobile computing device, a smart phone, a cellular telephone, a handheld computer, a server, a server array or server farm, a web server, a network server, an Internet server, a tablet, a work station, a mini-computer, a mainframe computer, a supercomputer, a network appliance, a web appliance, a distributed computing system, multiprocessor systems, or combination thereof. The elements of the system may be implemented in hardware, a combination of hardware and software, or software. For example, an element may be implemented as a process running on a processor, a hard disk drive, multiple storage drives (of optical and/or magnetic storage medium), an object, an executable, a thread of execution, a program, and/or a computer. One or more elements may reside within a process and/or thread of execution, and an element may be localized on one computer and/or distributed between two or more computers as desired for a given implementation. The embodiments are not limited in this manner.

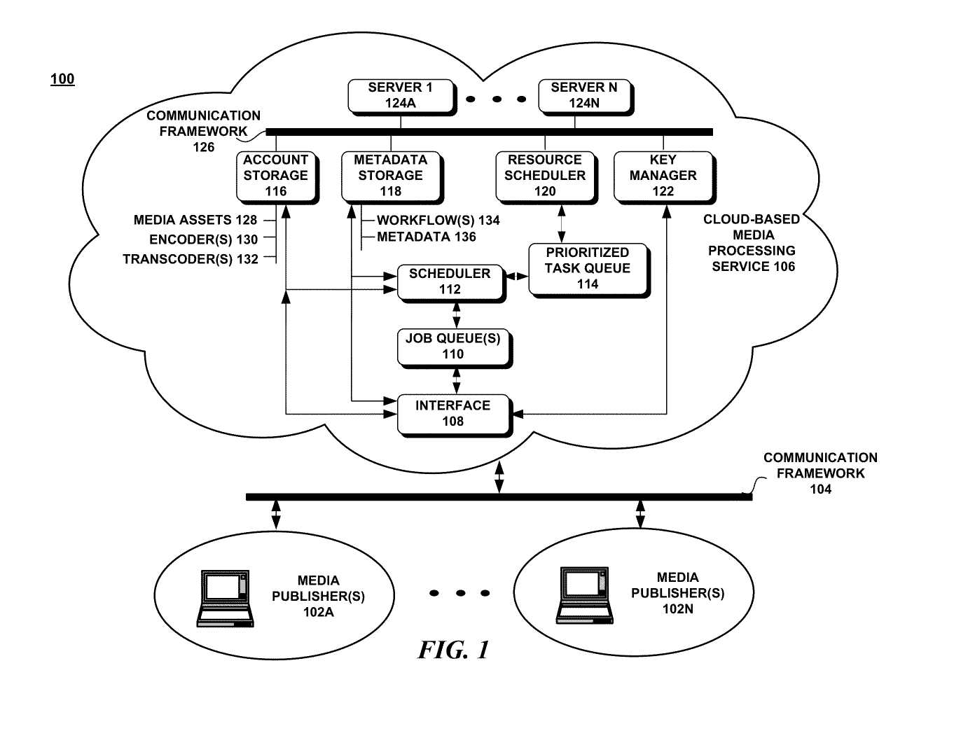

Although the system 100 as shown in FIG. 1 has a limited number of elements in a certain topology, it may be appreciated that the system 100 may include more or less elements in alternate topologies as desired for a given implementation.

Attention now turns to a discussion of the workflows. A workflow is a template of a media transformation. The workflow is composed of an ordered sequence of tasks that performs a media transformation. A job is collection of sequences that follow the order of a workflow.

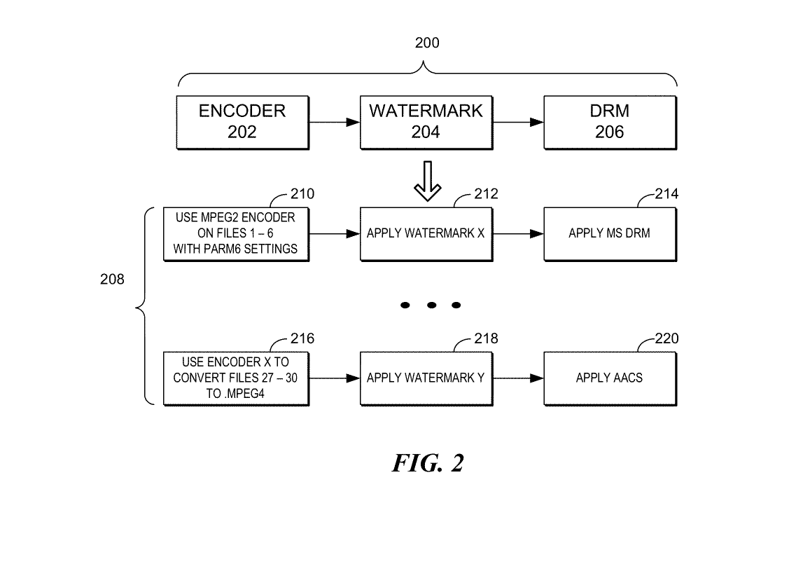

Turning to FIG. 2, there is shown an exemplary encoder workflow. The encoder workflow 200 may include a sequence composed of an encoder task 202, a watermark task 204, and a digital rights management (DRM) task 206. The encoder workflow prepares a video file for commercial distribution by encoding one or more video files using a specific encoder with specific settings, followed by application of a digital video watermark, and then followed by application of a digital rights management technology.

An encoder compresses a digital video file into a compressed format. There are various video encoders available for commercial distribution such as, without limitation, the Microsoft® Expression® Encoder, Windows® Azure Media Encoder, and the like. Encoders are characterized by various factors such as the video quality per bit rate, the supported video resolution, compression speed, and the supported operating system. A media publisher may intend that certain video files are encoded with specific settings that meet an intended purpose.

A digital video watermark may be used to identify ownership of the copyright to a video file. The digital video watermark may be implemented as a software application that is applied to a compressed video file. The digital video watermark application embeds additional data in a video file to identify its copyright owner. There are various digital video watermark technologies that may be applied to a video file and the media publisher specifies which watermark is to be applied in a job.

A DRM technology enforces the media publisher's policies and rules for usage of the video file. The DRM technology restricts what a user can do with a video file. The DRM technology may restrict the user from copying or redistributing the media asset or restrict the user from playing the media asset on certain devices and for a certain amount of times. There are various types of DRM technology, such as Microsoft's PlayReady® DRM, Apple's FairPlay® DRM, and so forth.

As shown in FIG. 2, there is a job 208 having hundreds of tasks. The first sequence of tasks contains an encoder task 210 that uses an MPEG2 encoder to encode video files 1-6 using the parameter settings found in file, PARM6. Digital video watermark task 212 is then applied to each of these video files followed by a task 214 that applies Microsoft's DRM technology to the video file.

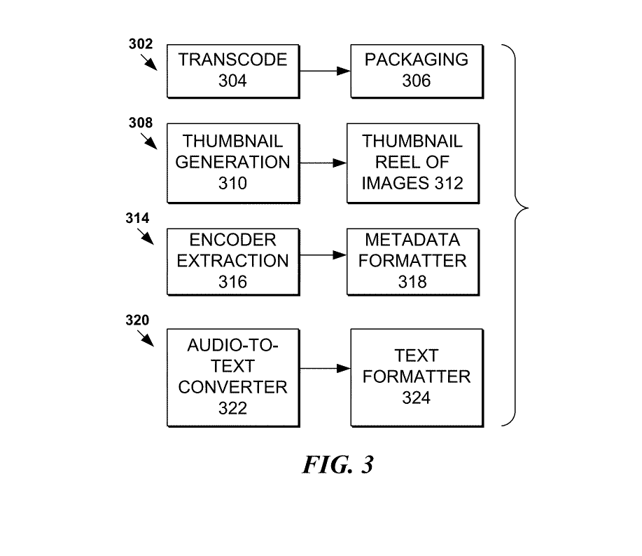

FIG. 3 illustrates additional exemplary workflows. There is shown a transcode workflow 302, a thumbnail generation workflow 308, a metadata generation workflow 314, and an audio-to-text conversion workflow 320. The transcode workflow 302 is a template of a video transcoding process where a first task 304 specifies a particular transcoder that may be used along with parameter settings. A second task 306 is applied after the transcoding process is performed which applies a packaging or container technology to the transcoded video file. Transcoding coverts a video file in one format to another format. Transcoding is commonly used in media production since most playback devices do not support all the various video formats that are available. As such, transcoding provides the media publisher the ability to generate a video file in a format that suits a playback device.

A thumbnail generation workflow 308 converts generates thumbnail images for select portions of a video file. The thumbnail generation workflow 308 may include a first task 310 which uses a thumbnail generation program to extract certain video frames from the video file and to convert them into a thumbnail image. The second task 312 may collate the thumbnails into a reel.

A metadata generation workflow 314 generates metadata for a video file. The metadata may include specific information regarding the video file, such as encoding scheme, encoding parameters, video resolution, and other media-specific information. The metadata generation workflow 314 may include a first task 316 that extracts the encoding information from a video file (i.e., encoder extraction) and the second task 318 may format the encoding information into a metadata file (e.g., metadata formatter).

An audio-to-text conversion workflow 320 generates a text file from an audio recording. The audio-to-text conversion workflow 320 may include a first task 322 that converts an audio file into text (i.e., audio-to-text converter) and a second task 324 that formats the text in a particular format.

Attention now turns to a description of embodiments of exemplary methods utilized by system 100. It may be appreciated that the representative methods do not necessarily have to be executed in the order presented, or in any particular order, unless otherwise indicated. Moreover, various activities described with respect to the methods may be executed in serial or parallel fashion, or any combination of serial and parallel operations. The methods may be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

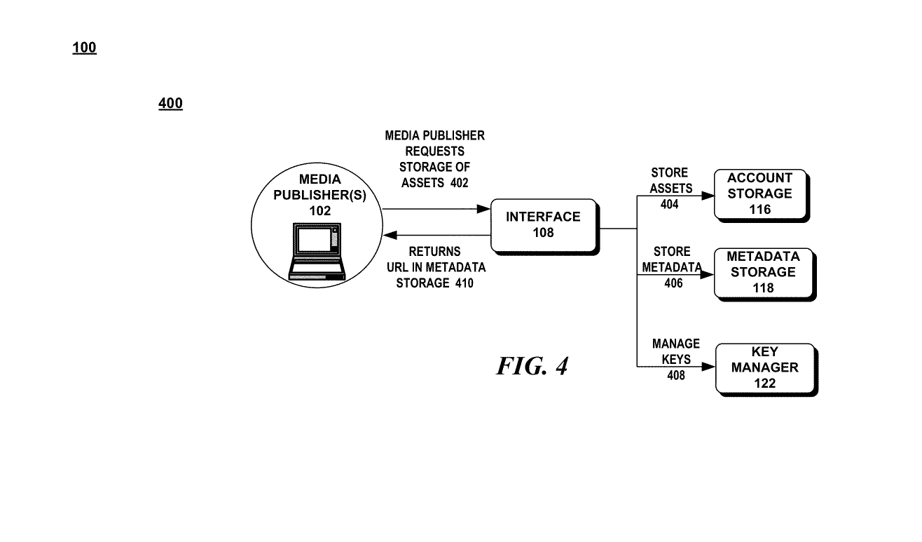

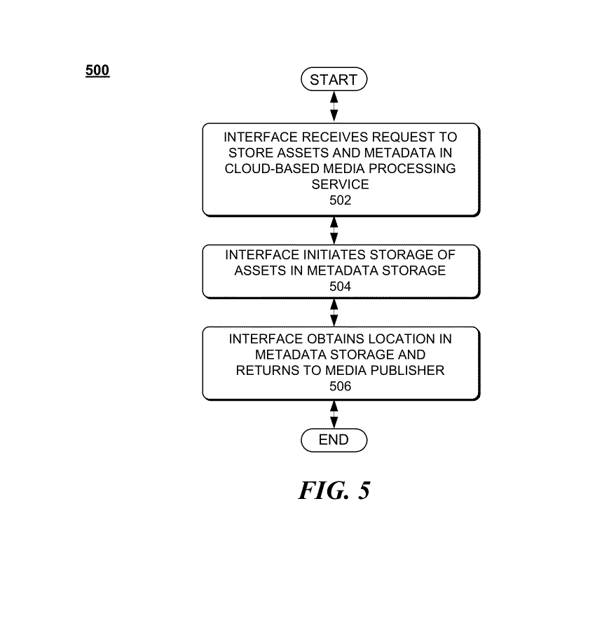

Attention now turns to a method 400, 500 for publishing media assets into the cloud-based media processing service. Turning to FIGS. 4 and 5, a media publisher has to upload the media assets to the cloud-based media processing service prior to initiating any jobs with the media assets. A media publisher may request storage of a media asset through a REST API that includes the media asset and metadata pertaining to the media asset (line 402). Alternatively, the media publisher may specify a location of the media asset and metadata. The interface 108 receives the request (block 502, line 402) and initiates storage of the assets in the account storage 116 reserved for the media publisher (line 404) and the metadata in the metadata storage 118 (line 406) (block 504). If there are any encryption keys in the metadata, the location of the encryption keys is sent to the key manager 122 (line 408).

The interface then obtains a location in the metadata storage where the results of any jobs utilizing the media assets will be stored (block 506). The interface returns the location to the media publisher (line 410, block 506). The location may be a URL. The media publisher uses this location to obtain information regarding the status of any jobs that the media publisher submits that use the media assets.

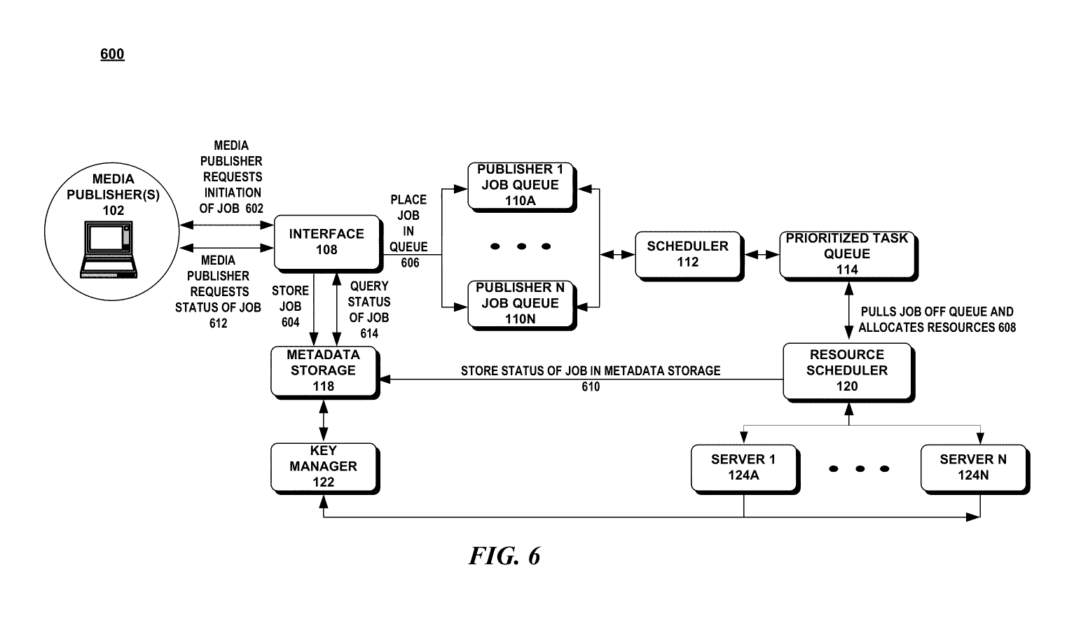

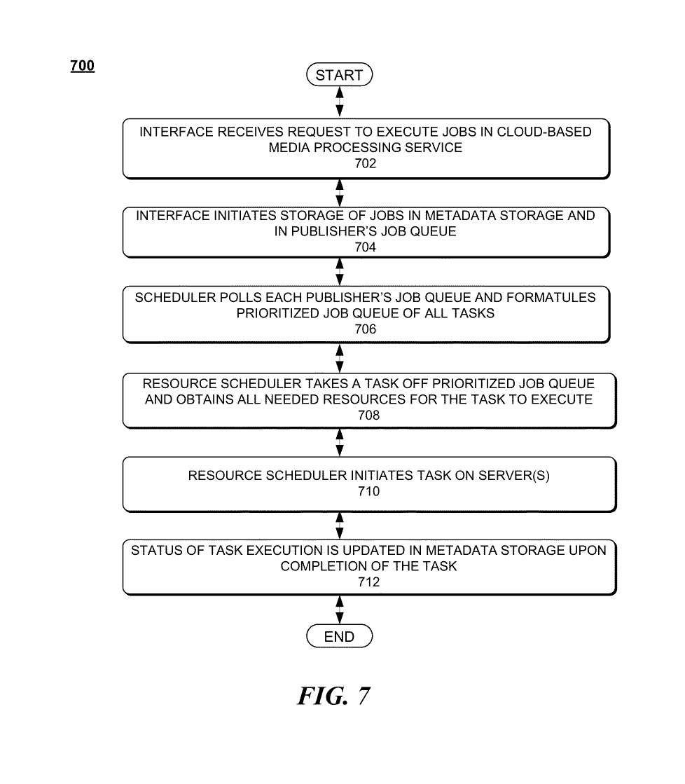

Attention now turns to a method 600, 700 for utilizing the services of the cloud-based media processing service. Turning to FIGS. 6 and 7, a media publisher 102 initiates a job through a request to the cloud-based media processing service. The request may be made via one or more REST APIs which is received and processed by the interface 108 (block 702, line 602). The interface places the jobs in the metadata storage 118 (line 604) and in the media publisher's job queue 110 (line 606, block 704).

When a media publisher subscribes to the cloud-based media processing service, the media publisher indicates the manner in which its jobs are to be processed. For example, a media publisher may request that its jobs are to be processed within a certain time frame of when they are submitted. Alternatively, the media publisher may request that its jobs are to be processed when the cloud-based media processing service has idle time, routinely at a certain day and time for a designated time period, and so forth. The scheduler takes this timing information into consideration and associates a priority scheme for each media publisher that the scheduler uses to poll each of the publisher's job queue in order to meet the media publisher's constraints.

The scheduler 112 polls each publisher's job queue 110 in accordance with the media publisher's priority scheme and formulates a single prioritized task queue 114 (block 706). The scheduler 112 screens each task in a job to sort the tasks into a prioritized order. The tasks are then placed in the prioritized order into the prioritized task queue 114.

The resource scheduler 120 takes each task off the prioritized task queue 114 and allocates the needed resources for the task to execute (line 608, block 708). The resource scheduler 120 allocates one or more servers 124 to implement the tasks. The resource scheduler 120 ensures that the servers 124 have the needed program modules, such as encoders, transcoders, watermark modules, DRM modules, to perform a task. In addition, the resource scheduler 120 places a key agent on the server to interact with the key manager 122 to obtain a session/public/private encryption key that may be needed to encrypt or decrypt a media asset in order to perform a video transformation. When the resource scheduler 120 has allocated all the needed resources, the resource scheduler initiates the task on the servers 124 (block 710). The resource scheduler 120 monitors execution of the task on the servers 124. When the task completes execution, the resource scheduler 120 places a status of the task in the metadata storage (line 610, block 712). A media publisher 102 may then access the metadata storage location 118 to learn of the status of all the tasks in the job (lines 612, 614).

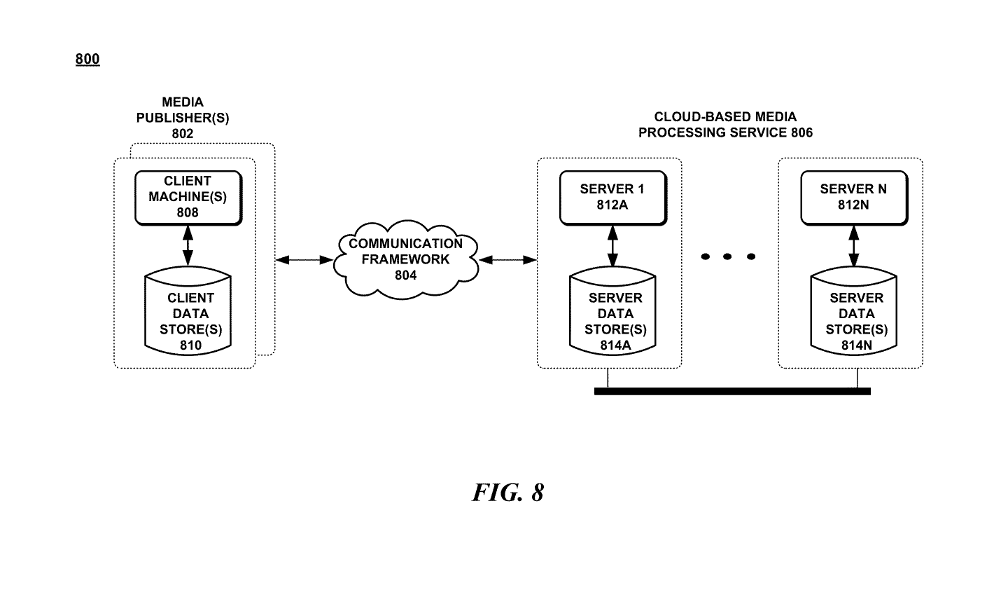

Attention now turns to a discussion of an exemplary operating environment. Referring now to FIG. 8, there is shown a schematic block diagram of an exemplary operating environment 800. The embodiments may be applied to an operating environment 800 having one or more media publishers 802 in communication through a communications framework 804 with a cloud-based media processing service 806. It should be noted that the operating environment 800 is exemplary and is not intended to suggest any limitation as to the functionality of the embodiments.

Each media publisher 802 may include one or more client machines 808 communicatively coupled to one or more client data stores 810. A client machine 808 may be embodied as a hardware device, a software module, or a combination thereof. The client 808 may be any type of electronic device, such as, without limitation, a mobile device, a personal digital assistant, a mobile computing device, a tablet, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The client machine 808 may also be embodied as a software module having instructions that execute in a single execution path, multiple concurrent execution paths (e.g., thread, process, etc.), or in any other manner.

A cloud-based media processing service 806 may include one or more servers 812A-812N (collectively, “812”) communicatively coupled to one or more server data stores 814A-814N (collectively, “814”). Each server 812 may be communicatively coupled to other servers through any type of communication interconnect, such as a LAN, WAN, and so forth. A server 812 may be embodied as a hardware device, a software module, or as a combination thereof. The server 812 may be any type of electronic device capable of executing programmable instructions such as, without limitation, a mobile device, a personal digital assistant, a mobile computing device, a tablet, a smart phone, a cellular telephone, a handheld computer, a server, a server array or server farm, a blade server, a web server, a network server, an Internet server, a work station, a mini-computer, a mainframe computer, a supercomputer, a network appliance, a web appliance, a distributed computing system, multiprocessor systems, or combination thereof. The server 812 may also be embodied as a software module having instructions that execute in a single execution path, multiple concurrent execution paths (e.g., thread, process, etc.), or in any other manner

The communications framework 804 facilitates communications between the client machines 808 and the servers 812 in the cloud-based media processing service 806. The communications framework 804 may embody any well-known communication techniques, such as techniques suitable for use with packet-switched networks (e.g., public networks such as the Internet, private networks such as enterprise intranet, and so forth), circuit-switched networks (e.g., the public switched telephone network), or a combination of packet-switched networks and circuit-switched networks (with suitable gateways and translators).

A client machine 808 and a server 812 may include various types of standard communication elements designed to be interoperable with the communications framework 804, such as one or more communications interfaces, network interfaces, network interface cards, radios, wireless transmitters/receivers, wired and/or wireless communication media, physical connectors, and so forth. Examples of wired communications media may include a wire, cable, metal leads, printed circuit boards, backplanes, switch fabrics, semiconductor material, twisted-pair wire, coaxial cable, fiber optics, a propagated signal, and so forth. Examples of wireless communications media may include acoustic, radio frequency spectrum, infrared, and other wireless media.

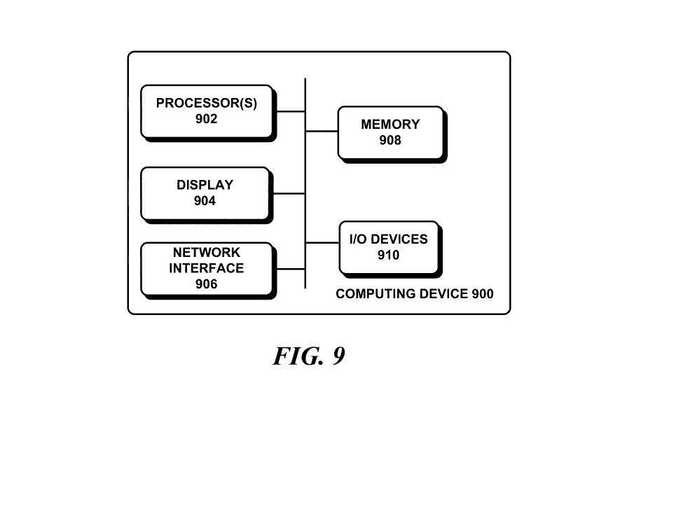

FIG. 9 illustrates an exemplary computing device used as a client machine 808 or server 812. The computing device 900 may have one or more processors 902, a display 904, a network interface 906, a memory 908, and I/O devices 910. A processor 902 may be any commercially available processor and may include dual microprocessors and multi-processor architectures. The display 904 may be any visual display unit and it may be embedded within a computing device or physically separated from it. The network interface 906 facilitates wired or wireless communications between the computing device 900 and a communications framework.

The memory 908 may be any computer-readable storage media that may store executable procedures, applications, and data. It may be any type of computer-readable memory device such as random access memory, read-only memory, magnetic storage, volatile storage, non-volatile storage, optical storage, DVD, CD, floppy disk drive, and the like. The computer-readable storage media does not pertain to propagated signals, such as modulated data signals transmitted through a carrier wave. The memory 908 may also include one or more external storage devices or remotely located storage devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method, the method comprising:
providing at least one workflow, each workflow specifying one or more tasks that transform a media asset from a first format to a second format;
receiving one or more jobs from one or more media publishers through a web-accessible interface, each job having the tasks specified in a workflow;
associating with each media publisher a priority for executing tasks; and
executing each task in accordance with the priority associated with the media publisher requesting execution of the task.

2. The computer-implemented method of claim 1, wherein the workflow specifies an encoding task, a digital watermark task, and a digital rights management task.

3. The computer-implemented method of claim 1, wherein the workflow specifies a transcoding task and a packaging task.

4. The computer-implemented method of claim 1, wherein the workflow specifies a thumbnail generator task.

5. The computer-implemented method of claim 1, wherein the workflow specifies an audio-to-text conversion task.

6. The computer-implemented method of claim 1, further comprising:
allocating a first storage location for each media publisher, the storage location storing the media assets.

7. The computer-implemented method of claim 1, further comprising:
prior to executing each task, configuring a job queue for each media publisher, the job queue including all jobs requested by a media publisher for execution.

8. The computer-implemented method of claim 7, further comprising:
polling each job queue for pending tasks in accordance with a priority scheme associated with a media publisher.

9. The computer-implemented method of claim 8, further comprising:
arranging each pending task in accordance with the priority scheme.

10. The computer-implemented method of claim 9, wherein the media asset is a select one of a video file, an audio file, a text file, and an image file.

11. A computer-implemented system, the system comprising:
an interface device, for receiving a plurality of jobs from one or more media publishers, each job requesting to transform a media asset in accordance with a workflow, the workflow specifying an order of tasks in a job that transforms a media asset from a first format to a second format, the media publishers interacting with the interface device through a web interface;
a scheduler device, for receiving tasks from the media publishers and configuring an order of the tasks based on a priority scheme associated with each media publisher; and
a resource scheduler device, for allocating resources needed to execute each task and initiating execution of each task.

12. The system of claim 11, wherein the media publishers interact with the interface device through REST APIs.

13. The system of claim 11, further comprising:
a first storage device having storage allocated to at least one media publisher, wherein the interface device receives a request to store a media asset and initiates storage of the media asset in the first storage device associated with the media publisher.

14. The system of claim 11, further comprising:
a plurality of job queues, each job queue associated with a select media publisher;
wherein the scheduler device polls each job queue in accordance with a priority scheme associated with the select media publisher to generate the order of the tasks.

15. The system of claim 11, wherein the workflow includes an encoder task, a digital watermark task, and a digital rights management task.

16. The system of claim 11, wherein the workflow includes a transcoder task and a packaging task.

17. A computer-implemented method, the method comprising:
utilizing a workflow to generate one or more jobs, each job transforming a media asset from a first format to a second format, each workflow specifying one or more tasks that perform a transformation in a prescribed order, the workflow accessible from a cloud-based media processing service, each job including one or more tasks of a workflow; and
requesting, through one or more REST APIs , execution of one or more jobs within the cloud-based media processing service.

18. The computer-implemented method of claim 17, further comprising:
requesting storage of the media assets, used in a job, in the cloud-based media processing service prior to execution of a job.

19. The computer-implemented method of claim 17, further comprising:
accessing a storage location in the cloud-based media processing service to obtain a status of execution of a job.

20. The computer-implemented method of claim 17, wherein a workflow includes one of an encoder task, a transcoder task, an audio-to-text conversion task, a thumbnail generation task, and an encoder extraction task.
